(19) United States
(12) Patent Application Publication
(10) Pub. No.: US 2010/0223558 A1
(43) Pub. Date: Sep. 2, 2010

(54) REMOTE DESKTOP CONNECTION TO ANY PRIVATE DESKTOP TO TAM E-SSO ACCESS AGENT

(75) Inventor: Jiangtao Feng, Singapore (CN)

Correspondence Address: CANTOR COLBURN LLP - IBM AUSTIN, 20 Church Street, 22nd Floor, Hartford, CT, 06103, US

(73) Assignee: International Business Machines Corporation, Armonk, NY (US)

(21) Appl. No.: 12/394,687

(22) Filed: Feb. 27, 2009

(51) Int. Cl. H04L 9/32; G06F 3/048; G06F 15/16

(52) U.S. Cl. 715/741

(57) ABSTRACT

A method for enabling a client computer to remotely connect to any existing user desktop hosted under a window session in a host computer is provided. The method includes receiving user credentials in a first user interface of an access managing application; and inserting master credentials into a second user interface of an authentication system in response to the first user interface receiving the user credentials enabling the session to switch from the host computer to the client computer without deleting any existing user desktops in the host computer.

### BACKGROUND

The present invention relates to a system and method for enabling a user to remotely connect to any existing user desktop hosted under a window session in a host computer.

TAM E-ESSO Access Agent client software is a single sign-on solution. With a single “master” password or another form of user identification, such as radio frequency identification (RFID) badge, fingerprint, the user enjoys the convenience of subsequent automatic log-on to all window, web, Java™ and terminal applications. When a user turns on their computer and logs on to their desktop, such as, for example their Windows™ desktop, Windows™ (XP, 2000, Vista) creates four conventional desktops, which include a default desktop, a winlogon desktop, a screensaver desktop (created when necessary), and a disconnect desktop under the same Windows™ session (e.g., Windows™ session 0).

Terminal Service (TS) technology, which is used by Windows™ XP's Fast User Switching feature, allows multiple user desktops to run concurrently where each of the four desktops described above are hosted in a completely new Windows™ session. For example, when a second user logs on to the TS enabled computer, TS will create a new Windows™ session (e.g., Windows™ session 1) and create the same four desktops inside it. A user can switch between desktops through the Windows™ XP's Fast User Switching feature.

To support this multi-desktop functionality on Windows™ XP and Windows™ 2000, the luxury of using TS is not available. Private Desktop™ technology, which is used by Access Agent, is used instead of TS technology because most corporate computers are part of a domain and Windows™ XP's Fast User Switching feature is disabled once a computer is part of a domain. Further, Windows™ 2000, which also needs to be supported by Access Agent, does not have the Fast User Switching feature.

Private Desktop™ is a feature enabled by Access Agent that allows multiple user desktops and sessions to run simultaneously on a Windows™ XP and 2000 machine under the same Windows™ session (e.g., Window™ session 0). Users can retain their own desktop and programs while another user is using the machine. Many users find it useful to use a remote desktop protocol (RDP) client to remotely connect to a desktop on a machine (e.g., personal computer). If the machine is a TS server, then it is not difficult to remotely connect into a desktop on that machine because it is handled by the TS itself. However, Private Desktop™ is not running on a terminal service server; rather it is running on Windows™ XP or Windows™ 2000 and allowing remote connection into any desired private desktop must be handled by Access Agent. In Windows, if a user tries to remotely connect into a Private Desktop™ machine using their own credentials and is not the “AutoAdminLogon” user, which is recognized to Windows™ as the currently logged on user who is running on the default desktop, Windows™ will determine that it is a different user who is trying to remotely connect and delete all existing user desktops in Window™ session 0.

### BRIEF SUMMARY

In accordance with one embodiment, a method for enabling a client computer to remotely connect to any existing user desktop hosted under a window session in a host computer is provided. The method includes receiving user credentials in a first user interface of an access managing application; and inserting master credentials into a second user interface of an authentication system in response to the first user interface receiving the user credentials enabling the session to switch from the host computer to the client computer without deleting any existing user desktops in the host computer.

In accordance with another embodiment, a system for enabling a client computer to remotely connect to any existing user desktop hosted under a window session in a host computer is provided. The system includes a first user interface of an access managing application configured to receive user credentials; and an automatic login module of the access managing application configured to insert master credentials into a second user interface of an authentication system in response to the first user interface receiving the user credentials enabling the session to switch from the host computer to the client computer without deleting any existing user desktops in the host computer.

In accordance with yet another embodiment, a computer program product is provided. The computer program product includes a computer readable medium having a computer program stored thereon containing instructions that, when executed by a computer, implement a method, the method comprising receiving user credentials in a first user interface of an access managing application; and inserting master credentials into a second user interface of an authentication system in response to the first user interface receiving the user credentials enabling the session to switch from the host computer to the client computer without deleting any existing user desktops in the host computer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of a computing system installed an access managing application in accordance with one exemplary embodiment;

FIG. 2 is a block diagram of the access managing application and its various user interfaces in accordance with one exemplary embodiment of the present invention;

FIG. 3 is a flow diagram that illustrates a method for enabling a client computer to remotely connect to any existing user desktop hosted under a window session in a host computer in accordance with one exemplary embodiment of the present invention;

FIG. 4 is a flow diagram of the security measures taken by the access managing application once the session is switched to the client computer in accordance with one exemplary embodiment of the present invention; and

FIG. 5 is a flow diagram of additional security measures taken by the access managing application once the session is switched to the client computer in accordance with one exemplary embodiment of the present invention.

### DETAILED DESCRIPTION

Exemplary embodiments of a remote access managing system and a method of enabling a client computer to remotely connect to any existing user desktop hosted under a logged-in session in a host computer without deleting all existing user desktop on the host computer in accordance with the present invention will now be described with reference to the drawings. The exemplary access managing system described herein enables a user to remotely connect into any of the user desktops on a host computer installed with an access managing application (e.g., Access Agent) with multi-desktop technology feature (e.g., Private Desktop™) much like a user can remotely connect into any of the user desktops on a conventional native terminal server. Further, the exemplary access managing system described herein enables a user to disconnect remote connection and switch the session back to the host computer without deleting all existing user desktops on the host computer.

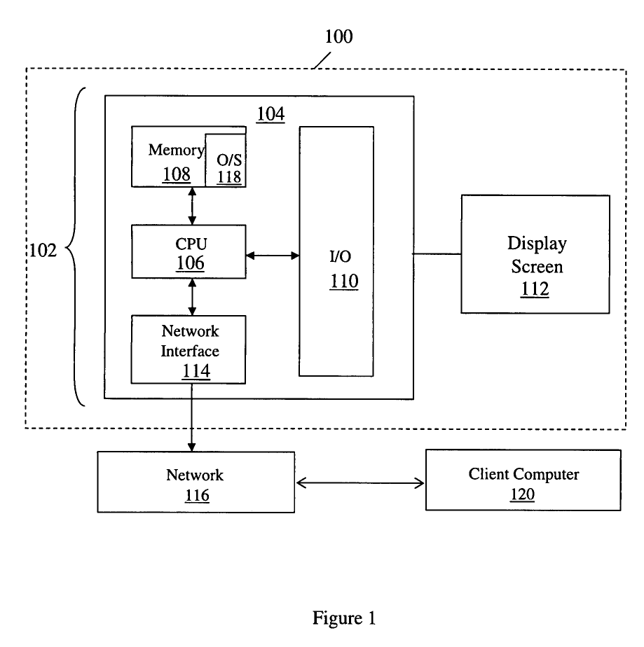

Now referring to the drawings, FIG. 1 illustrates a computing system 100 that includes a control system in accordance with one exemplary embodiment of the present invention. The computing system 100 is shown to include a computer 102. The computer is configured to support an access managing application/module (e.g., TAM ESSO Access Agent) having a multi-desktop technology (e.g., Private Desktop™) feature enabled for carrying out the methods described herein in accordance with one exemplary embodiment. In accordance with one exemplary embodiment, the computer 102 is also configured to support other computer applications/modules/programs, such as, for example, an authentication system, for carrying out the methods described herein. The authentication system may be a graphical identification and authentication module (GINA), a Credential Provider, or other authentication systems. In accordance with one exemplary embodiment, the authentication system is a graphical identification and authentication (GINA) module.

The computer 102 includes a controller 104 having a central processing unit (CPU) 106, a memory 108, which includes a read-only memory (ROM) and a volatile memory such as a random access memory (RAM) in accordance with one exemplary embodiment. The controller 104 further includes an input/output (I/O) interface 110, which is in signal communication with a display screen 112. As can be appreciated, the computing system 102 can include any computing device, including but not limited to, a desktop computer, a laptop, a server, a portable handheld device (e.g., personal digital assistant (PDA) or otherwise. For ease of discussion, exemplary embodiments will be discussed in the context of a computer.

The computer 102 can further include a network interface 114 coupled to a network 116. The network 116 operably enables communication between the computer 102 and external systems (e.g., other computers) and by the implementation of remote desktop protocol (RDP) client software installed in the external systems. In other words, the network 116 and RDP client software permits a user operating another computer, (e.g., a client computer) to remotely connect to computer 102, which will be referred to hereinafter as the host computer.

The CPU 104 operably communicates with the memory 108, and I/O interface 110. The computer readable media including memory 108 may be implemented using any of a number of known memory devices such as PROMs, EPROMs, EEPROMs, flash memory or any other electric, magnetic, optical or any combination of memory devices capable of storing data, some of which represent executable instructions used by CPU 106.

When the computer 102 is in operation, the CPU 106 is configured to execute instructions by fetching instructions within memory 108 to generally control operations of the computer 102 pursuant to the instructions. In one exemplary embodiment, the memory 106 includes a suitable operating system (OS) 118, such as, for example, a Windows™ operating system (e.g., Windows™ XP, Windows™ 2000, Windows™ Vista, etc.). The operating system 118 is configured to control the execution of the computer programs (e.g., access managing application) installed in the memory 108 and provides scheduling, input-output control, file and data management, memory management, and communication control and related services. The CPU 106 can be any conventional processing unit configured for carrying out the methods and/or functions described herein. In one exemplary embodiment, the CPU 106 comprises a combination of hardware and/or software/firmware with a computer program that, when loaded and executed, permits the CPU 106 to operate such that it carries out the methods described herein.

Computer program means or computer program used in the present context of exemplary embodiments of the present invention include any expression, in any language, code, notation, or the like of a set of instructions intended to cause a system having information processing capabilities to perform a particular function either directly or after conversion to another language, code, notation, or the like, reproduction in a different material form.

In accordance with one exemplary embodiment, the CPU 106 includes the access managing system configured for supporting the access managing application/module enabled with multi-desktop technology for providing sign-on capabilities and desktop managing capabilities as used in the exemplary embodiments described herein. The access managing application is an access solution that enables subsequent automatic logins to all window, web, java, and terminal applications on the host computer 102 in accordance with one exemplary embodiment. Multi-desktop technology allows multiple user desktops to run simultaneously on a machine, such as a Windows™ machine. In accordance with one exemplary embodiment, the host computer 102 is installed with an access managing application (e.g., Access Agent) that enables a client computer, which is indicated as client computer 120, to remotely connect to any existing user desktop hosted under a logged on session in the host computer 102 without deleting all existing user desktop on the host computer 102. In accordance with one embodiment, the access managing application is configured to generate and manage various user interfaces for enabling this method of remote connection. The various user interfaces are managed via a mechanism of the access managing application's implementation of the GINA module, which is known to perform all identification and authentication user interactions and is conventionally a component of the operating system (e.g., Windows™)

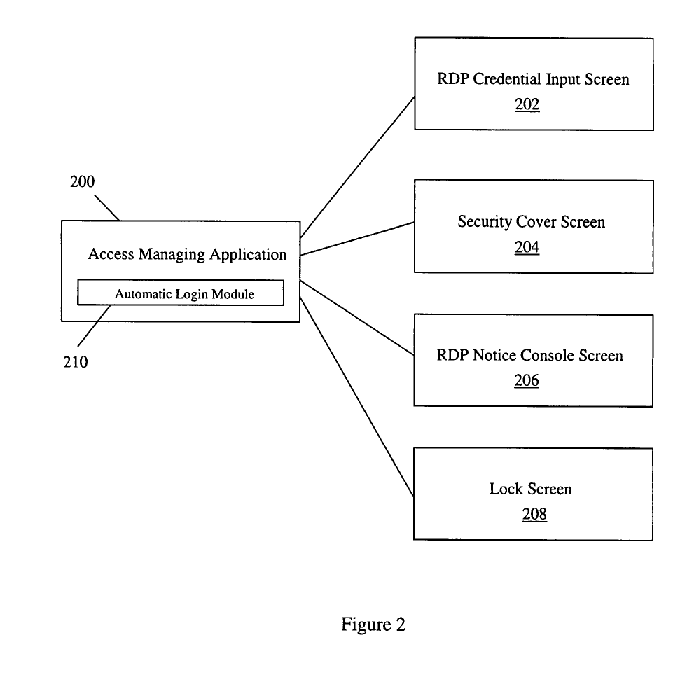

FIG. 2 illustrates a schematic of the user interfaces generated and managed by the access managing application, which is indicated as access managing application 200, installed in host computer 102 in accordance with one exemplary embodiment. In accordance with one exemplary embodiment, the access managing application 200 is configured to generate and display an RDP credential input screen 202 at the client computer 120. The RDP credential input screen 202 operably receives user credentials from a user (e.g., client user) operating the client computer 120 and attempting to connect to the session in host computer 102. Such user credentials can be in the form of an ID/password, RFID badge, fingerprint, etc. The RDP credential input screen 202 is generally the access managing application's implementation of the GINA module's welcome screen that is conventionally displayed in the RDP client.

In accordance with one exemplary embodiment, the access managing application 200 is further configured to generate and display a security cover screen 204 at the host computer 102 in response to the session switching from the host computer 102 to the client computer 120. The security cover screen 204 operably blocks the user input and covers the current user desktop displayed at the host computer 102 in response to the logged on session switching from the host computer 102 to the client computer 120. For example, the security screen can be a black screen with some status message so that when the access managing application 200 switches the logged on session at the host computer 102 to the client computer 120, the client user will not see the user desktop of another valid user that may be currently displayed at the host computer 102 while access managing application 200 switches to the user desktop associated with the user credentials. Of course, other methods for securing the desktop currently displayed at the host computer 102 can be used in other exemplary embodiments.

In accordance with one exemplary embodiment, the access managing application 200 is further configured to generate and display an RDP console notice screen 206 in response to the session switching from the host computer 102 to the client computer 120. The RDP console notice screen 206 can operate to inform the user at the host computer 102 that an external computer is remotely connected to the host computer 102 in accordance with one embodiment. The RDP console notice screen 206 is generally the access managing application's implementation of the GINA module's welcome screen that is normally displayed at the console.

In accordance with one exemplary embodiment, the access managing application 200 is further configured to generate and display a lock screen 208 at the host computer 102 when the client computer 120 is disconnected from the host computer 102. The lock screen 208 operably prevents unauthorized users from operating the host computer 102.

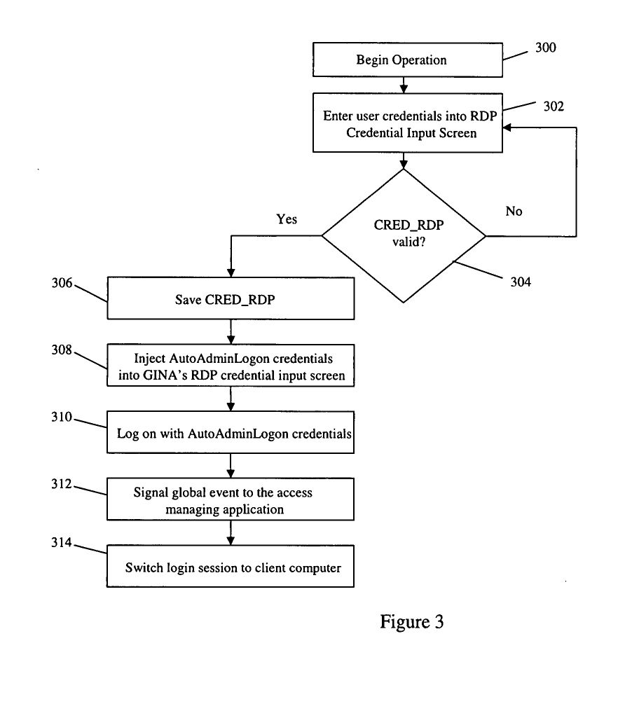

FIG. 3 illustrates a flow diagram of a method for enabling the client computer 120 to remote connect to any existing user desktop hosted under a logged on session in the host computer 102 without deleting all existing user desktop on the host computer 102 in accordance with one exemplary embodiment. Beginning the operation at block 300 user credentials are entered into the RDP credential input screen 202 at block 302. In accordance with one embodiment, the RDP credential input screen 202 is displayed at the client computer 120. At block 304, it is determined whether the user credentials (CRED_RDP) are valid. If the answer is no, the method returns to block 302 for entry of new user credentials. If the answer is yes, the user credentials are saved at block 306. In one embodiment, the user credentials are saved to the access managing application 200. Proceeding to block 308, AutoAdminLogon credentials are injected or inserted into GINA's RDP credential input screen. The AutoAdminLogon credentials are the master credentials to the default desktop on the host computer. In other words, the AutoAdminLogon user is the currently logged on user running on the default desktop. In accordance with one embodiment, an automatic login module 210 of access managing application 200 automatically injects the AutoAdminLogon credentials into the GINA module's user interface. For example, once the client user clicks the “connect” button in the RDP credential input screen 202, the RDP credential input screen 202 closes itself and the GINA RDP credential input screen is displayed and the automatic login module 210 instantly injects AutoAdminLogon credentials into the GINA RDP credential input screen. As such, the GINA module is “fooled” into believing that it is the AutoAdminLogon user trying to remotely connect to the host computer 102 even though it is the client user attempting to RDP whose user credentials are different from the AutoAdminLogon credentials. Therefore, none of the existing user desktops hosted under the logged in session in host computer 102 are deleted and/or logged off. Next, log on with the AutoAdminLogon credentials at block 310. Signal a global event to the access managing application 200 at block 312. This notifies the access managing application that remote connection occurred. In block 314, switch the logged on session to the client computer 120. In accordance with one exemplary embodiment, the operating system 118 switches the session to the client computer 120 in response to inserting the AutoAdminLogon credentials into the GINA module's user interface without triggering any harmful desktop log offs or deleting any existing user desktops in the host computer 102.

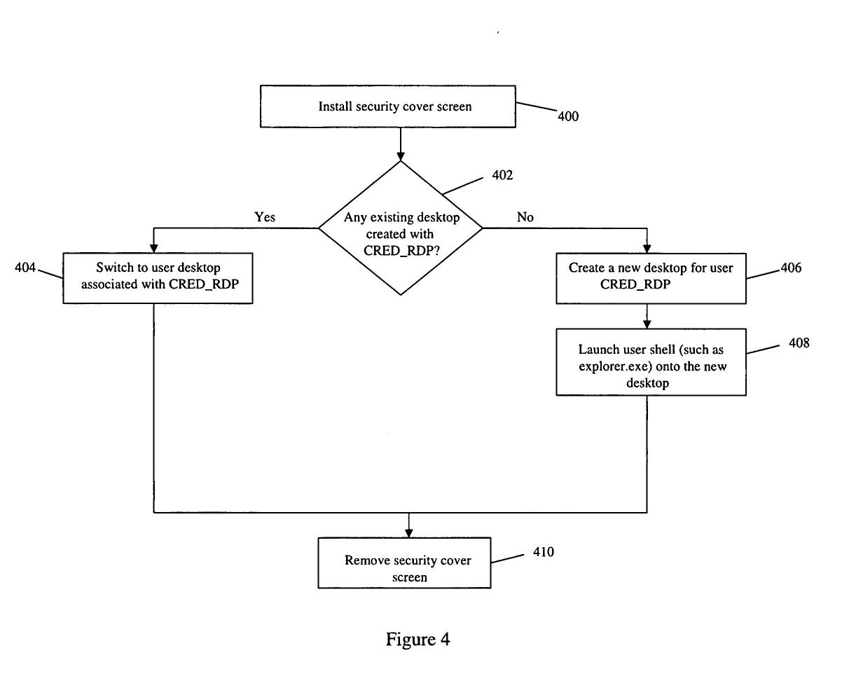

In operation, once the session is switched from the host computer 102 to the client computer 120 and the global event notifies the access managing application that remote connection occurred, the access managing application 200 installs the security cover screen 204 in accordance with one embodiment. FIG. 4 illustrates a flow diagram of the security measures taken by access managing application 200 once the session is switched to the client computer 120 in accordance with one exemplary embodiment. At block 400, the security cover screen 204 is installed. In accordance with one embodiment, the security cover screen 204 is displayed at the client computer 120 and blocks or covers the client user's view of the current user desktop displayed at the host computer 102. Thus, desktop information of the currently logged on user at the host computer 102 is not compromised. At block 402, it is determined whether there is an existing desktop created for CRED_RDP. If the answer is yes, the access managing application switches to the user desktop associated with CRED_RDP at block 404. In other words, if a user desktop has already been created for CRED_RDP, the access managing application switches to the user desktop associated with CRED_RDP. If the answer is no, the access managing application creates a new desktop for user CRED_RDP at block 406. In other words, if no desktop has been created for CRED_RDP, the access managing application creates one for user CRED_RDP. At block 408, the access managing application launches a user shell (e.g., explorer.exe) onto the new desktop created. At block 410, the security cover screen 204 is removed at the client computer 120. Thus, the access managing application 200 can create another private desktop for the client user if no desktop currently exists in the host computer 102 for that user.

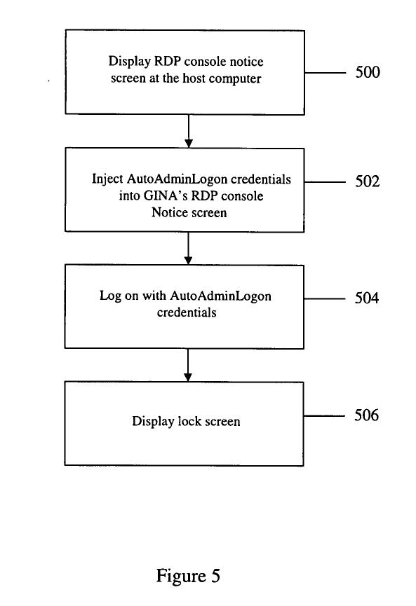

FIG. 5 illustrates additional security measures taken by access managing application 200 once the session is switched to the client computer 120 in accordance with one exemplary embodiment. The RDP console notice screen 206 is displayed at the host computer at block 500. In accordance with one exemplary embodiment, the RDP console notice screen is displayed at the host computer 102 and informs the user operating the host computer 102 that an external computer (e.g., client computer 120) is remotely connected to the host computer 102. When remote connection is disconnected, accessing managing application automatically detects this event. AutoAdminLogon credentials are injected or inserted into a GINA's RDP console notice screen in block 502. On remote disconnect, automatic login module 210 of access managing application 200 automatically injects the AutoAdminLogon credentials into the GINA's RDP console notice screen switching the session back to the host computer 102 in accordance with one embodiment. For example, on remote disconnect, the RDP console notice screen 206 closes itself and the GINA RDP console notice screen is displayed and the automatic login module 210 instantly injects AutoAdminLogon credentials into the GINA RDP console notice screen. As such, the GINA module is “fooled” into believing that it is the AutoAdminLogon trying to unlock back. This prevents the existing user desktops hosted under the session in host computer 102 from being deleted and/or logged off during the unlocking or switching. At block 504, the AutoAdminLogon credentials are logged on. At block 506, the lock screen 208 is displayed at the host computer in response to inserting AutoAdminLogon credentials into the GINA RDP console screen 206. The lock screen 208 is configured to prevent unauthorized users from operating the host computer 102 in accordance with one exemplary embodiment. In accordance with one exemplary embodiment, before the lock screen is displayed, a security cover screen will be shown so that the user at the host computer will not be able to see other user desktops.

The user at the host computer 102 can disconnect the client user instead of waiting for the client user to disconnect remote connection. In accordance with one embodiment, the user at the host computer 102 can press a button on display screen 112 to disconnect the client user. Alternatively, the user at the host computer 102 can be prompted for permission to disconnect (e.g., entering master credentials) in accordance with one embodiment. Of course, other ways of disconnecting the client user at the host computer 102 can be used in other exemplary embodiments and should not be limited to the examples described herein.

The access managing application 102 is configured to manage the additional private user desktops on top of the default desktop hosted under a session in the host computer 102. Specifically, the access managing application 102 is configured to create user desktops, delete user desktops, and switch between user desktops.

It should be understood that the client computer can include any computing device, including but not limited to, a desktop computer, a laptop, a server, a portable handheld device (e.g., personal digital assistant (PDA) or otherwise.

It should further be understood that although exemplary embodiments are discussed in the context of a GINA module, other authentication systems (e.g., Credential Provider) can be used in other exemplary embodiments and should not be limited to the examples set forth herein.

The technique described in the exemplary embodiments above allow a user to RDP or remotely connect to any existing desktop on a multi-desktop—enabled machine without triggering any harmful desktop log offs. Even if the user does not have an existing desktop on the machine, the user is still able to RDP into the machine, which will create a new desktop for that user. With this capability, multi-desktop technology enables any client computer to remotely connect or RDP into any of its desktops much like users can remote connect into any TS desktop.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for enabling a client computer to remotely connect to any existing user desktop hosted under a window session in a host computer, comprising:
receiving user credentials in a first user interface of an access managing application; and
inserting master credentials into a second user interface of an authentication system in response to the first user interface receiving the user credentials enabling the session to switch from the host computer to the client computer without deleting any existing user desktops in the host computer.

2. The method as in claim 1, further comprising generating a global event to notify the access managing application of the remote connection.

3. The method as in claim 1, further comprising generating a third user interface in response to the session switching from the host computer to the client computer.

4. The method as in claim 3, wherein the third user interface is a security cover screen displayed at the client computer and is configured to block the view of the current user desktop displayed at the host computer and also disable user input capabilities, and wherein the third user interface is generated by the access managing application.

5. The method as in claim 1, further comprising connecting the client computer to a user desktop in the host computer utilizing the access managing application, and wherein the user desktop is associated with the user credentials.

6. The method as in claim 1, further comprising generating a fourth user interface in response to the session switching from the host computer to the client computer.

7. The method as in claim 6, wherein the fourth user interface is a console notice screen displayed at the host computer and is indicative that the client computer is remotely connected to the host computer, and wherein the fourth user interface is generated by the access managing application.

8. The method as in claim 1, further comprising switching the session from the client computer back to the host computer by inserting the master credentials into a fifth user interface of the authentication system.

9. The method as in claim 8, further comprising generating a sixth user interface in response to inserting the master credentials into the fifth user interface, the sixth user interface is a lock screen preventing unauthorized users from operating the host computer.

10. The method as in claim 1, wherein the first user interface is a credential input screen configured to receive user credentials, and wherein the first user interface is generated by the access managing application.

11. The method as in claim 1, wherein the access managing application is installed in the host computer and includes an automatic login module configured to insert the master credentials into the second user interface.

12. A system for enabling a client computer to remotely connect to any existing user desktop hosted under a window session in a host computer, comprising:
a first user interface of an access managing application configured to receive user credentials; and
an automatic login module of the access managing application configured to insert master credentials into a second user interface of an authentication system in response to the first user interface receiving the user credentials enabling the session to switch from the host computer to the client computer without deleting any existing user desktops in the host computer.

13. The system as in claim 12, further comprising a third user interface of the access managing application configured to block the view of the current user desktop displayed at the host computer and disable user input capabilities in response to the session switching from the host computer to the client computer.

14. The system as in claim 13, wherein the third user interface is a security screen displayed at the client computer.

15. The system as in claim 12, further comprising a fourth user interface of the access managing application configured to indicate that the client computer is remotely connected to the host computer.

16. The system as in claim 15, wherein the fourth user interface is a console notice screen displayed at the host computer.

17. The system as in claim 12, wherein the automatic login module is further configured to insert the master credentials into a fifth user interface of the authentication system to switch the session back to the host computer.

18. The system as in claim 17, further comprising a sixth user interface of the access managing application configured to prevent unauthorized users from operating the host computer in response to inserting the master credentials into the fifth user interface.

19. The system as in claim 12, wherein the access managing application is installed in the host computer and has a multi-desktop solution enabled and wherein the authentication system is a graphical identification and authentication (GINA) module or a credential provider.

20. A computer program product, comprising:
a computer readable medium having a computer program stored thereon containing instructions that, when executed by a computer, implement a method, the method comprising receiving user credentials in a first user interface of an access managing application; and inserting master credentials into a second user interface of an authentication system in response to the first user interface receiving the user credentials enabling the session to switch from the host computer to the client computer without deleting any existing user desktops in the host computer.
